(19) United States
(12) Patent Application Publication
(10) Pub. No.: US 2026/0297419 A1
(43) Pub. Date: Oct. 1, 2026

(54) PARTICULATE COMPOSITIONS FOR IRON SULFIDE REMEDIATION

(71) Applicant: ChampionX LLC, Sugar Land, TX (US)

(72) Inventors: Maria Celeste Tria, Houston, TX (US); Kai He, Sugar Land, TX (US); Yuan Ding, Sugar Land, TX (US); Vittoria Balsamo, Fulshear, TX (US)

(21) Appl. No.: 19/570,746

(22) Filed: Mar. 18, 2026

Related U.S. Application Data
(60) Provisional application No. 63/777,228, filed on Mar. 25, 2025.

(51) Int. Cl. C09K 8/532; C09K 8/66; C09K 8/68; C09K 8/80; E21B 41/02; E21B 43/267

(52) U.S. Cl. CPC C09K 8/532; C09K 8/665; C09K 8/68; C09K 8/80; E21B 41/02; E21B 43/267

(57) ABSTRACT

Particulate compositions for remediating iron sulfide in distressed water sources include composite particles having both an iron sulfide remediation agent and an elution retarder present in the same particle. Slurries including the particulate compositions may be injected into a subterranean reservoir in conjunction with a fracturing process to establish an oil or gas well, where the composite particles obtain iron sulfide remediation of the subterranean reservoir for period of time that is at least 10% longer than the same method carried out in the absence of the elution retarder.

### BACKGROUND

The combination of hydrogen sulfide (H₂S) and/or sulfate-reducing bacteria along with iron present within oil and gas producing wells and water injection and supply wells can cause the formation of various iron sulfide species. The ratio of iron to sulfide in these species depends on conditions within a well including temperature, pressure, pH, and hydrogen sulfide concentration. Iron sulfide scale is one of the main types of inorganic scales that block oil and gas wells. Conventionally, hydrochloric acid (HCl) was used to remove iron sulfide scale; however, this approach releases H₂S, and consequently, tubular corrosion and formation damage are accelerated. In some cases, iron sulfide formation can occur during the early life of oil well production following completion, leading to a fast decline in production and equipment failure.

More recently, improved iron sulfide remediation agents have been developed. Iron sulfide remediation agents are compounds that are effective to dissolve, sequester, scavenge, neutralize, or precipitate iron sulfide in aqueous fluids. Such agents are effective to treat aqueous fluids such as produced water that is contaminated with iron sulfide, and mixtures thereof with crude oil produced by an oil or gas well. Iron sulfide remediation agents known to be effective for treating water sources contaminated with iron sulfide include phosphonate salts, phosphonium salts, and organic acids that are capable of chelating or complexing with iron sulfide. Such organic acids include ethylenediaminetetraacetic acid (EDTA), diethylenetriaminepentaacetic acid (DTPA), and hydroxyacids and salts thereof, such as those listed in U.S. Pat. No. 11,597,868, the contents of which are incorporated herein in their entirety and for all purposes.

The foregoing iron sulfide remediation agents are effective to reduce or remove iron sulfide from water sources and/or reduce or eliminate the effects thereof in water sources, most often by formation of coordination bonds (chelation) with iron. Accordingly, they are usefully injected into subterranean reservoirs during well formation to offset the formation of iron sulfide scale where significant amounts of H₂S and/or iron compounds are present. However, since these agents are water soluble, they fail to offer extended protection in constantly flowing water sources, since the compounds are quickly dissolved and carried away with the flow. For example, produced water flowing from a newly established well during the flowback process quickly reduces the amount of the iron sulfide remediation agent injected therein. Rapid depletion of the iron sulfide remediation agent can lead to early “souring” of producing wells having significant amounts of hydrogen sulfide and iron therein.

Accordingly, it would be desirable to extend the duration of protection provided to a flowing water source by an iron sulfide remediation agent. It would be desirable to provide controlled rate of eluting release of an iron sulfide remediation agent in an aqueous stream. It would be desirable to avoid well equipment failure due to the presence of iron sulfide for extended periods after establishment of an oil or gas well. It would be desirable to prevent production loss during the early stages of oil and gas well production.

### SUMMARY

To solve the foregoing problems, disclosed herein are particulate compositions comprising, consisting essentially of, or consisting of composite particles, the composite particles comprising, consisting essentially of, or consisting of an iron sulfide remediation agent and an elution retarder. In embodiments, the ratio of the iron sulfide remediation agent to the elution retarder in the composite particles is between 99:1 and 1:99 by weight.

The iron sulfide remediation agent comprises, consists essentially of, or consists of one or more compounds selected from phosphonate salts, phosphonium salts, organic acids and/or conjugate bases thereof, or any combination thereof. The elution retarder comprises, consists essentially of, or consists of one or more coupling agents and/or salts thereof, one or more carriers, or any combination thereof, wherein the carrier comprises, consists essentially of, or consists of a silica gel, a hydrophilic polymer, a charcoal, a clay, calcium sulfate, a diatomaceous earth, a zeolite, an alumina, a vermiculite, or any combination thereof; and the hydrophilic polymer comprises, consists essentially of, or consists of a polyvinyl alcohol homopolymer or copolymer, a polyacrylate homopolymer or copolymer, a polymethacrylate homopolymer or copolymer, a carbohydrate, a gelatin, a derivative or crosslinked version of any of these, or any combination thereof.

Also disclosed herein are methods of forming a composite particulate comprising, consisting essentially of, or consisting of composite particles. In some embodiments, the methods include dissolving or dispersing an iron sulfide remediation agent in a first solvent to form an iron sulfide remediation agent solution, then contacting the iron sulfide remediation agent solution with an elution retarder, then removing at least a portion of the first solvent from the contacted combination. In some such embodiments, a non-solvent is added to the contacted combination prior to removing first solvent, wherein addition causes one or both of the elution retarder and the iron sulfide remediation agent to precipitate from the contacted combination; and the non-solvent is then removed along with the first solvent. In other embodiments, the methods include dissolving or dispersing an elution retarder in a second solvent to form an elution retarder solution, then contacting the elution retarder solution with the iron sulfide remediation agent, then removing at least a portion of the second solvent from the contacted combination. In some such embodiments, a non-solvent is added to the contacted combination prior to removing second solvent, wherein addition causes one or both of the elution retarder and the iron sulfide remediation agent to precipitate from the contacted combination; and the non-solvent is then removed along with the second solvent. In still other embodiments, the methods include dissolving or dispersing an iron sulfide remediation agent in a first solvent to form an iron sulfide remediation agent solution, and dissolving or dispersing an elution retarder in a second solvent to form an elution retarder solution, then contacting the iron sulfide remediation agent solution with the elution retarder solution, then removing at least a portion of the first and second solvents from the contacted combination. In some such embodiments, a non-solvent is added to the contacted combination prior to removing first and second solvents, wherein addition causes one or both of the elution retarder and the iron sulfide remediation agent to precipitate from the contacted combination; and the non-solvent is then removed along with the first and second solvents. In still other embodiments, the methods include dissolving or dispersing an iron sulfide remediation agent and a first elution retarder in a first solvent to form a combined solution, contacting the combined solution with a second elution retarder, then removing at least a portion of the first solvent from the contacted combination. In some such embodiments, a non-solvent is added to the contacted combination prior to removing the first solvent, wherein addition causes one or more of the first elution retarder, the second elution retarder, and the iron sulfide remediation agent to precipitate from the contacted combination; and the non-solvent is then removed along with the first solvent. In still other embodiments, the methods include dissolving or dispersing an iron sulfide remediation agent and a first elution retarder in a first solvent to form a combined solution, and dissolving or dispersing a second elution retarder in a second solvent to form an elution retarder solution, then contacting the combined solution with the elution retarder solution, then removing at least a portion of the first and second solvents from the contacted combination. In some such embodiments, a non-solvent is added to the contacted combination prior to removing first and second solvents, wherein addition causes one or more of the first elution retarder, the second elution retarder, and the iron sulfide remediation agent to precipitate from the contacted combination; and the non-solvent is then removed along with the first and second solvents. In still other embodiments, the methods include dissolving or dispersing an iron sulfide remediation agent and a first elution retarder in a first solvent to form a combined solution, then removing at least a portion of the first solvent from the combined solution to provide a first dried combination; then dissolving or dispersing a second elution retarder in a second solvent to form an elution retarder solution, then contacting the first dried combination with the elution retarder solution to form a contacted combination, then removing at least a portion of the second solvent from the contacted combination. In some such embodiments, a non-solvent is added to the combined solution prior to removing the first solvent, wherein addition causes one or more of the first elution retarder and the iron sulfide remediation agent to precipitate from the combined solution; and the non-solvent is then removed along with the first solvent. In other such embodiments, a non-solvent is added to the contacted combination prior to removing the second solvent, wherein addition causes the second elution retarder to precipitate; and the non-solvent is then removed along with the second solvent.

In any of the foregoing embodiments of the method of making a particulate composition, the iron sulfide remediation agent, the first elution retarder, the second elution retarder, the first solvent, the second solvent, and the non-solvent are each independently selected and may be the same or different. In some such embodiments, one or both of the first and second solvent comprises, consists essentially of, or consists of water, methanol, ethanol, isopropanol, or any combination thereof. In some such embodiments, the non-solvent comprises, consists essentially of, or consists of methanol, ethanol, isopropanol, butanol, and acetone, or any combination thereof.

Also disclosed herein are slurries that are useful in conjunction with fracturing processes employed to establish an oil or gas well. The slurries comprise, consist essentially of, or consists of a mixture of a fracturing fluid and a particulate composition comprising, consisting essentially of, or consisting of composite particles, the composite particles comprising, consisting essentially of, or consisting of an iron sulfide remediation agent and an elution retarder. In some embodiments, the fracturing fluid comprises, consists essentially of, or consists of water. In embodiments, the particulate composition is present in an amount of about 0.1 wt % to about 10 wt % of the slurry. In some embodiments, the slurry further includes a proppant. In embodiments, the proppant is present in an amount of about 1 wt % to about 15 wt % of the slurry.

Also disclosed herein are methods of treating a subterranean reservoir to remediate iron sulfide, the method comprising, consisting essentially of, or consisting of: injecting a slurry into the subterranean reservoir, the slurry comprising a fracturing fluid and a particulate composition comprising composite particles, the composite particles comprising an iron sulfide remediation agent and an elution retarder. In embodiments, the treating is carried out contemporaneously with a well fracturing operation. The methods provide iron sulfide remediation of the subterranean reservoir for period of time that is at least 10% longer than the same method carried out in the absence of the elution retarder.

### BRIEF DESCRIPTION OF THE DRAWINGS

A brief description of the drawings is as follows:

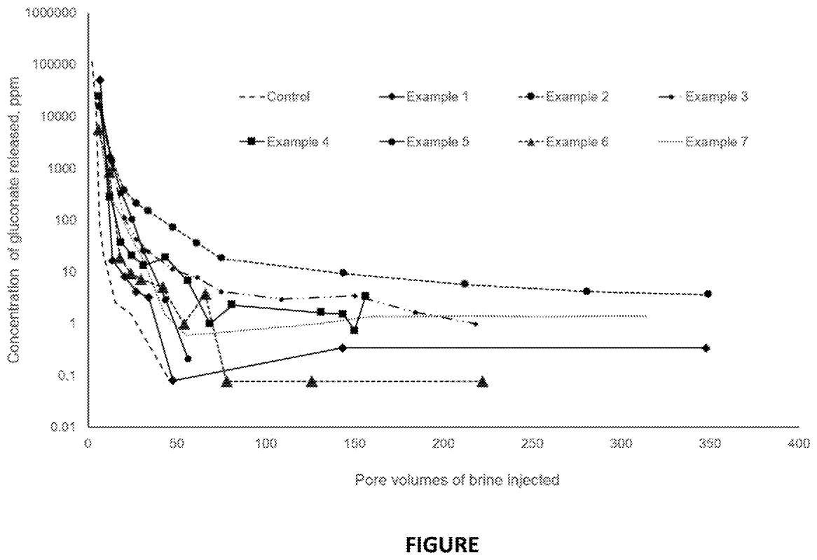

The FIG. 1s a plot showing amount of sodium gluconate released from an elution column containing a particulate composition of the invention, as a function of the number of pore volumes of a synthetic brine injected into the column.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

As used herein, the term “solvent” means any compound or mixture thereof that is a liquid a temperature between −20° C. and 100° C. at 1 atmosphere pressure.

As used herein, the term “water source” means water or an aqueous fluid.

As used herein, “aqueous fluid” means water including at least one other liquid, gas, or solid dissolved or dispersed therein.

As used herein, “distressed water” or “distressed water source” means a water source having a measurable amount of iron sulfide dispersed or present therein, for example as a precipitate; and/or having a measurable amount of hydrogen sulfide and iron dispersed or present therein.

As used herein, an “iron sulfide remediation agent” is any compound that is effective to dissolve, sequester, scavenge, neutralize, or precipitate iron sulfide in aqueous fluids.

As used herein, the term “hydrophilic” applied to a polymeric or particulate material means that 0.1 g or more of the polymer or particulate dissolves—or in the case of a polymer, disperses completely—in 1 liter of pure water at 70° C./1 atm; or that 1 kg of the polymer or particulate adsorbs or absorbs 1 g or more of pure water at 70° C./1 atm.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “substantially” means “consisting essentially of”, as that term is construed in U.S. patent law, and includes “consisting of” as that term is construed in U.S. patent law. For example, a solution that is “substantially free” of a specified compound or material may be free of that compound or material, or may have a minor amount of that compound or material present, such as through unintended contamination, side reactions, or incomplete purification. A “minor amount” may be a trace, an unmeasurable amount, an amount that does not interfere with a value or property, or some other amount as provided in context. A composition that has “substantially only” a provided list of components may consist of only those components, or have a trace amount of some other component present, or have one or more additional components that do not materially affect the properties of the composition. Additionally, “substantially” modifying, for example, the type or quantity of an ingredient in a composition, a property, a measurable quantity, a method, a value, or a range, employed in describing the embodiments of the disclosure, refers to a variation that does not affect the overall recited composition, property, quantity, method, value, or range thereof in a manner that negates an intended composition, property, quantity, method, value, or range. Where modified by the term “substantially” the claims appended hereto include equivalents according to this definition.

As used herein, any recited ranges of values contemplate all values within the range and are to be construed as support for claims reciting any sub-ranges having endpoints which are real number values within the recited range. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

### First Embodiments

Disclosed in first embodiments herein is a particulate composition comprising, consisting essentially of, or consisting of composite particles, the composite particles comprising, consisting essentially of, or consisting of both an iron sulfide remediation agent and an elution retarder present in the same particle. In any one or more first embodiments herein, the iron sulfide remediation agent is a compound or mixture of compounds that has a melting point greater than 70° C., is at least partially soluble in pure water at 50° C./1 atm, and is capable of reacting with, complexing with, sequestering, or scavenging an iron sulfide precipitate present within a distressed water source, such that contact of the iron sulfide remediation agent with a distressed water source results in a treated water source. A treated water source includes a reduced level of iron sulfide precipitate compared to the distressed water source, or even no measurable iron sulfide precipitate. The reduced level of iron sulfide precipitate is manifest as the reduction of measurable iron sulfide precipitate present as dispersed in the water source, or present at an interface of the water source and a solid surface contacting the water source, such as a pipe or a vessel, over a selected period of time.

In any one or more first embodiments herein, the iron sulfide remediation agent comprises, consists essentially of, or consists of a phosphonate compound, a phosphonium compound, an organic acid and/or conjugate base thereof, or any combination thereof in any ratio.

In some first embodiments herein, the iron sulfide remediation agent comprises, consists essentially of, or consists of a phosphonate compound having the formula

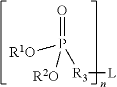

wherein each R¹ and R² are independently selected from hydrogen, sodium, potassium, ammonium, alkylammonium, alkanolammonium, magnesium, or calcium, each R³ is independently selected from C1-C4 hydrocarbyl, n is an integer between 1 and 5, and L is hydrogen or a linking moiety comprising one or more carbon atoms and/or one or more nitrogen atoms and/or one or more oxygen atoms. In some embodiments, L is nitrogen and n is 3. In some embodiments, L is oxygen and n is 2.

In some first embodiments, the phosphonate compound comprises, consists essentially of, or consists of amino trimethylene phosphonic acid (ATMP) or a conjugate base thereof, diethylenetriamine penta(methylene phosphonic acid) (DTPMPA) or a conjugate base thereof, bis(hexamethylenetriaminepentamethylenephosphonic acid) (BHMTPMP) or a conjugate base thereof, ethylene diamine tetra(methylene phosphonic acid) (EDTMPA) or a conjugate base thereof, amino trimethylene phosphonic acid (ATMP) or a conjugate base thereof, polyamino polyether methylene phosphonic acid (PAPEMP) or a conjugate base thereof, or hydroxyethyl amino-di(methylene phosphonic acid) (HEMPA) or a conjugate base thereof. In some first embodiments, the phosphonate compound is a mixture of two or more of the foregoing phosphonate compounds, in any ratio.

In some first embodiments herein, the iron sulfide remediation agent comprises, consists essentially of, or consists of a phosphonium salt. In some such embodiments the phosphonium salt comprises, consists essentially of, or consists of tetrakis(hydroxymethyl)phosphonium sulfate (THPS).

In any one or more first embodiments herein, the iron sulfide remediation agent comprises, consists essentially of, or consists of an organic acid or conjugate base thereof comprising one or more hydroxy moieties and/or one or more tertiary amino moieties; or any mixture thereof. In some first embodiments, the iron sulfide remediation agent comprises, consists essentially of, or consists of an amino acid such as ethylenediaminetetraacetic acid (EDTA), diethylenetriaminepentaacetic acid (DTPA), glutamic acid diacetic acid (GLDA), and related structures. In some first embodiments, the amino acid is a mixture of two or more of the foregoing amino acids, in any ratio.

In some first embodiments, the organic acid comprises, consists essentially of, or consists of a hydroxyacid, a conjugate base/salt thereof, a derivative thereof, or any mixture thereof. Hydroxyacids are organic acids having at least one hydroxyl group. In some embodiments, the hydroxyacid has 3-12 carbons, that is, 3, 4, 5, 6, 7, 8, 9, 10, 11, or 12 carbons. In some embodiments, the hydroxyacid has 1-12 hydroxy groups (hydroxyl groups), that is, 1, 2, 3, 4, 5, 6, 7, 8, 9, 10, 11, or 12 hydroxy groups, often 1 to 8 hydroxy groups, or 2 to 8 or even 3 to 6 hydroxy groups. Suitable hydroxyacids include sugar acids such as aldonic acids, which have the formula HO₂C(CHOH)ₙCH₂OH, where n is at least 1 and is often 2, 3, 4, 5, 6, 7, 8, 9, or 10, such as between 2 and 10 or between 3 and 8. Aldonic acids include gluconic acid (n=4), e.g. D-gluconic acid, which arises from oxidation of the aldose of D-glucose. Other aldonic acids include altronic acid, threonic acid, ribonic acid, tagaturonic acid, xylonic acid, lyxonic acid, gluconic acid, galactonic acid, mannonic acid, fuconic acid, glucoheptonic acid, gulonic acid, and idonic acid. Suitable sugar acids also include aldaric acids, which have the formula HO₂C—(CHOH)_{n′}—CO₂H, where n′ is at least 1 and is often 2, 3, 4, 5, 6, 7, 8, 9, or 10, such as between 2 and 10 or between 3 and 8. Aldaric acids include allaric acid, altraric acid, glucaric acid, arabinaric acid, idaric acid, mannaric acid, and arabinonic acid. Suitable sugar acids also include alduronic (uronic) acids, which have the formula HO₂C—(CHOH)_{n″}—C(O) H, where n″ is at least 1 and is often 2, 3, 4, 5, 6, 7, 8, 9, or 10, such as between 2 and 10 or between 3 and 8. Alduronic acids include iduronic acid, fructuronic acid, glucuronic acid, galacturonic acid, and rhamnonic acid.

Other suitable hydroxyacids in first embodiments herein include octulosonic acid or another keto-functional hydroxyacid; citric acid, isocitric acid, homocitric acid, homoisocitric acid, dihomocitric acid, and glycans such as hyaluronic acid, a glycosaminoglycan. Suitable hydroxyacid derivatives in first embodiments herein include any of the foregoing compounds further including one or more aldehydo, dehydro, deoxy, erthyro, keto, C1-C3 alkyl, oxo, or threo functionalities, or any combination of two or more such functionalities. Suitable hydroxyacid derivatives also include structural isomers of any of the foregoing compounds (e.g. citric acid and isocitric acid are structural isomers). Suitable hydroxyacid salts in first embodiments herein include sodium, potassium, ammonium, alkylammonium, alkanolammonium, magnesium, or calcium salts of any of the foregoing hydroxyacids or derivatives thereof. In some first embodiments herein, the hydroxyacid is a mixture of two or more of the foregoing hydroxyacids, in any ratio.

In any one or more first embodiments herein, the elution retarder comprises, consists essentially of, or consists of a coupling agent or salt thereof, a carrier, or any combination thereof. In any one or more first embodiments herein, the coupling agent comprises, consists essentially of, or consists of one or more of hydroxylated and/or alkoxylated adducts of silicon, titanium, aluminum, or tin. Examples of suitable coupling agents are alkoxides of silicon, including tetraorthoethyl silicate, methyl triethoxysilane, and methyl trimethoxysilane; aluminum alkoxides such as aluminum isopropoxide, aluminum sec-butoxide, or aluminum tert-butoxide; titanium (IV) alkoxides such as titanium isopropoxide and titanium butoxide; tin (IV) alkoxides such as tin ethoxide or tin butoxide; and combinations of two or more of these. In any one or more first embodiments herein, the salt of a coupling agent is a sodium, potassium, ammonium, alkylammonium, alkanolammonium, magnesium, or calcium silicate, titanate, stannate, or aluminate. In any one or more first embodiments herein, the elution retarder comprises a coupling agent salt comprising sodium silicate.

In any one or more first embodiments herein, the carrier comprises, consists essentially of, or consists of a hydrophilic polymer, a hydrophilic particulate, or any combination thereof. Hydrophilic particulates are particulates that are capable of partially dissolving in a water source, such as water or produced water; or are capable of absorbing or adsorbing an amount of a water source, such as water or produced water. In some embodiments, 1 kg of a hydrophilic particulate is capable of adsorbing or absorbing 1 g or more of pure water at 70° C./1 atm. In some embodiments, 0.1 g or more of a hydrophilic particulate is capable of dissolving in 1 liter of pure water at 70° C./1 atm. In any one or more first embodiments herein, the hydrophilic particulate comprises, consists essentially of, or consists of a silica gel, a charcoal, a clay, a diatomaceous earth, a zeolite, an alumina, calcium sulfate, or any combination thereof. In some such embodiments, the hydrophilic particulate has a volume-based or mesh-based average particle size between 5 nm and 4 mm.

Suitable silica gels (CAS No. 112926-00-8) and related sorbents are commercially available as particulates, often having particle sizes of 10-500 mesh (ASTM mesh). Suitable charcoals include “activated” charcoal particulates (CAS No. 7440-44-0), which are macroporous, microporous, nanoporous, mesoporous, or nanotubular carbon particulates having dimensions ranging between 10 nm and 1 mm in at least one direction. Suitable clay minerals are particulates including silica, alumina and/or magnesia; potassium, sodium, and/or calcium counterions; and adsorbed water. Suitable clay compounds are particulate and/or layered and include kaolin-serpentine (kaolinite, halloysite, lizardite, chrysotile), pyrophyllite-talc, mica (illite, glauconite, celadonite), vermiculite, smectite (montmorillonite, nontronite, saponite), chlorite (sudoite, clinochlore, chamosite), sepiolite-palygorskite, interstratified clay minerals (e.g., rectorite, corrensite, tosudite), and allophane-imogolite. Clay minerals are available commercially as particulates having dimensions ranging between 10 nm and 1 mm in at least one direction.

In any one or more first embodiments herein, hydrophilic polymers are polymers that are capable of at least partially dissolving or dispersing in a water source, such as water or produced water; or are capable of absorbing or adsorbing an amount of a water source, such as water or produced water. In some embodiments, 1 kg of a hydrophilic polymer is capable of adsorbing or absorbing 1 g or more of pure water at 70° C./1 atm. In some embodiments, 0.1 g or more of a hydrophilic polymer is capable of dissolving in 1 liter of pure water at 70° C./1 atm. In any one or more first embodiments herein, suitable hydrophilic polymers comprise, consist essentially of, or consist of polyvinyl alcohol homopolymers and copolymers, derivatives thereof, and crosslinked versions thereof; homopolymers and copolymers of acrylic acid, derivatives thereof, crosslinked versions thereof and salts thereof (polyacrylate salts); homopolymers and copolymers of methacrylic acid, derivatives thereof, crosslinked versions thereof, and salts thereof; homopolymers and copolymers of acrylamide, derivatives thereof, crosslinked versions thereof, and salts thereof; gelatins; and carbohydrates including celluloses, polysaccharides, derivatives thereof, crosslinked versions thereof, and combinations of two or more of any of these.

Suitable carbohydrates include celluloses, starches (amylose polymers), alginic acid and/or sodium alginate, chitosans dextrans, β-glucans, fucoidans, laminarins, inulins, and heteropolysaccharides such as a pectins e.g. amylopectin. Suitable celluloses include cellulose, hemicellulose, microcrystalline cellulose, cellulose acetate, carboxymethylcellulose, hydroxymethylcellulose, and hydroxyethylcellulose.

Suitable polyvinyl alcohol homopolymers and copolymers include 80-100 mole % vinyl alcohol repeat units, that is, at least 80 mole % vinyl alcohol repeat units, or 80, 81, 82, 83, 84, 85, 86, 87, 88, 89, 90, 91, 92, 93, 94, 95, 96, 97, 98, 99, or even 100 mole % vinyl alcohol repeat units. In some first embodiments, a polyvinyl alcohol copolymer consists of vinyl alcohol and vinyl acetate repeat units. In some first embodiments, a suitable polyvinyl alcohol homopolymer or copolymer has a weight average molecular weight of about 5,000 g/mol to 100,000 g/mol, such as 5,000 g/mol to 10,000 g/mol, or 10,000 g/mol to 20,000 g/mol, or 20,000 g/mol to 30,000 g/mol, or 30,000 g/mol to 40,000 g/mol, or 40,000 g/mol to 50,000 g/mol, or 50,000 g/mol to 60,000 g/mol, or 60,000 g/mol to 70,000 g/mol, or 70,000 g/mol to 80,000 g/mol, or 80,000 g/mol to 90,000 g/mol, or 90,000 g/mol to 100,000 g/mol, or 10,000 g/mol to 50,000 g/mol, or 20,000 g/mol to 50,000 g/mol, or 20,000 g/mol to 70,000 g/mol.

In some first embodiments herein, the hydrophilic polymer is crosslinked. Any one of the hydrophilic polymers of first embodiments may be crosslinked, or two or more thereof reacted using conventional crosslinking materials and methods to form a crosslinked hydrophilic polymer. Suitable crosslinked hydrophilic polymers are formed by reacting e.g. a boronic acid/borate, dialdehyde/trialdehyde/tetraaldehyde, diisocyanate, diepoxide/triepoxide/tetraepoxide, or a polymer functionalized with borate, aldehyde, or epoxide groups with a hydrophilic polymer bearing hydroxyl or carboxylic acid groups; or by combining a divinyl, trivinyl, or tetravinyl monomer, such as N,N′-methylenebisacrylamide, ethylene glycol dimethacrylate, 1,4-butylene glycol dimethacrylate, trimethylolpropane triacrylate, or pentaerythritol tetraacrylate with one or more vinyl monomers in a chain polymerization reaction; or by ionically crosslinking hydrophilic polymers bearing carboxyl functionality using e.g. calcium or zinc ions. In some such embodiments, the crosslinked hydrophilic polymer is characterized as a particulate, and therefore may also be characterized as a hydrophilic particulate in accordance with definitions hereinabove. A crosslinked hydrophilic polymer particulate does not dissolve in a water source, but in some embodiments is capable of dispersing in a water source, such as water or produced water. A crosslinked hydrophilic polymer particulate is capable of absorbing or adsorbing an amount of a water source. In some embodiments, 1 kg of a crosslinked hydrophilic polymer particulate is capable of adsorbing or absorbing 1 g or more of pure water at 70° C./1 atm. In some embodiments, the crosslinked hydrophilic polymer particulate is macroporous, microporous, nanoporous, or mesoporous.

In any one or more first embodiments herein, the elution retarder is a combination of at least one coupling agent and at least one carrier, that is, one or more coupling agents and one or more carriers. In any one or more first embodiments herein, the elution retarder is a combination of a coupling agent salt and a carrier. In any one or more first embodiments herein, the elution retarder is a combination of a coupling agent, a coupling agent salt, and a carrier.

Further in any one or more first or subsequent embodiments herein, “an iron sulfide remediation agent” or “the iron sulfide remediation agent” means “one or more iron sulfide remediation agents” or “the one or more iron sulfide remediation agents” and accordingly includes mixtures of two or more iron sulfide remediation agents in the same particulate product, and/or in the same composite particulate. Further in first embodiments, “an elution retarder” or “the elution retarder” means “one or more elution retarders” or “the one or more elution retarders” and accordingly includes mixtures of two or more elution retarders in the same particulate product, and/or in the same composite particulate.

As noted above, first embodiments herein are particulate compositions. The particulate compositions of first embodiments consist of or consist essentially of solid particles. Overall, the particles of the particulate compositions of first embodiments may obtain an irregular shape, or a shape that is spherical or substantially spherical, plate-like or substantially plate-like, including irregularly shaped plates, i.e. flakes; fibrous or substantially fibrous. In such embodiments, “fibrous” refers to a particle having one spatial dimension (e.g. length) that is 10× or more greater than either of the other dimensions; and “plate-like” refers a particle having one spatial dimension (e.g. thickness) that is 10× or more smaller than either of the other dimensions. Water or another gaseous or liquid compound (e.g. solvent) may be adsorbed to the surface of the particles, or in some embodiments are part of the molecular structure of a carrier, e.g. clay; but the particulate is still characterized overall as a collection or group of discrete solid particles. In any one or more first embodiments herein, the particles of the particulate composition obtain a volume-based average particle size, or an average particle dimension in at least one direction that is between about 1 μm and about 4 mm, for example 1 μm to 5 μm, 5 μm to 10 μm, 10 μm to 20 μm, 20 μm to 50 μm, 50 μm to 100 μm, 100 μm to 200 μm, 200 μm to 500 μm, 500 μm to 1 mm, 1 mm to 2 mm, 2 mm to 3 mm, or 3 mm to 4 mm. In any one or more first embodiments herein, the particles of the particulate composition obtain a particle size via classifying screens that is between 1 μm and 2 mm, for example 1 μm to 5 μm, 5 μm to 10 μm, 10 μm to 20 μm, 20 μm to 50 μm, 50 μm to 100 μm, 100 μm to 200 μm, 200 μm to 500 μm, 500 μm to 1 mm, 1 mm to 2 mm, 2 mm to 3 mm, or 3 mm to 4 mm. In some embodiments, the particulate composition obtains a bimodal distribution of particle sizes.

Also as noted above, first embodiments herein are particulate compositions comprising, consisting essentially of, or consisting of composite particles, wherein the composite particles include both an iron sulfide remediation agent and an elution retarder. Accordingly, in first embodiments herein, each individual composite particle includes an amount of an iron sulfide remediation agent and an amount of an elution retarder. In some first embodiments, substantially all of the particles of the composite particulate composition are composite particles. In this context “substantially all” means that at least 90% by weight of the particles of a particulate composition are composite particles. In some first embodiments, the composite particulate composition consists of composite particles.

In any one or more first embodiments herein, the ratio of the iron sulfide remediation agent to the elution retarder in the particulate composition, or in a composite particle, is between 99:1 and 1:99 by weight, such as 99:1 to 1:1, 50:1 to 1:1, 20:1 to 1:1, 99:1 to 90:1, 90:1 to 80:1, 80:1 to 70:1, 70:1 to 60:1, 60:1 to 50:1, 50:1 to 40:1, 40:1 to 30:1, 30:1 to 20:1, 20:1 to 18:1, 18:1 to 16:1, 16:1 to 14:1, 14:1 to 12:1, 12:1 to 10:1, 10:1 to 9:1, 9:1 to 8:1, 8:1 to 7:1, 7:1 to 6:1, 6:1 to 5:1, 5:1 to 4:1, 4:1 to 3:1, 3:1, to 2:1, 2:1 to 1:1, 1:1 to 1:2, 1:2 to 1:3, 1:3k to 1:4, 1:4 to 1:5, 1:5 to 1:6, 1:6 to 1:7, 1:7 to 1:8, 1:8 to 1:9, 1:9 to 1:10, 1:10 to 1:12, 1:12 to 1:14, 1:14 to 1:16, 1:16 to 1:18, 1:18 to 1:20, 1:20 to 1:30, 1:30 to 1:40, 1:40 to 1:50, 1:50 to 1:60, 1:60 to 1:70, 1:70 to 1:80, 1:80 to 1:90, or 1:90 to 1:99 of the iron sulfide remediation agent to the elution retarder by weight.

In any one or more first embodiments herein, the particulate composition and/or one or more composite particles present therein optionally further include one or more adjuvants. The one or more adjuvants are optionally present in the particulate composition and/or one or more composite particles of first embodiments herein in a total amount of up to 10 wt %. That is, the one or more adjuvants are present in the particulate composition and/or the one or more composite particles of first embodiments herein in a total amount of 0% to 10 wt %. In embodiments, the one or more adjuvants include one or more drying agents such as silica flours, salts, barium sulfate, sodium carbonate, lime, or any combination thereof, and/or one or more suspending agents or viscosifiers, such as polyacrylate polymers and derivatives thereof, including crosslinked polyacrylates, polymethacrylate polymers and derivatives thereof, including crosslinked polymethacrylates, polyvinyl alcohol polymers and derivatives thereof, including crosslinked polyvinyl alcohols, polyacrylamide polymers and derivatives thereof, including crosslinked polyacrylamides.

In any one or more first embodiments herein, the amount of actives in a particulate composition or in a composite particle is the amount of iron sulfide remediation agent in the particulate composition or composite particle. Accordingly, the weight percent of actives in a particulate composition or composite particle of first embodiments herein can range from about 1 wt % to about 99 wt % based on the weight of the particulate composition or the composite particle respectively. For example, where the elution retarder is a coupling agent or salt thereof such as sodium silicate, the resulting particulate composition and/or composite particles may include 30 wt % actives or more, often 50 wt % actives or more, in some first embodiments up to 99 wt % actives, for example 30 wt %-40 wt %, 40 wt %-50 wt %, 50 wt %-60 wt %, 60 wt %-70 wt %, 70 wt %-80 wt %, 80 wt %-90 wt %, 90 wt %-95 wt %, or 95 wt %-99 wt % actives. Where the elution retarder is a carrier such as a silica gel or a high-porosity particulate such as a silica gel or carbon particle, the resulting particulate composition and/or composite particles may include 70 wt % actives or less, often 50 wt % actives or less, in some first embodiments as low as 10 wt % actives, such as 10 wt %-20 wt %, 20 wt %-30 wt %, 30 wt %-40 wt %, 40 wt %-50 wt %, 50 wt %-60 wt %, or 60 wt %-70 wt % actives. Where the elution retarder is a hydrophilic polymer, such as polyvinyl alcohol, the resulting particulate composition and/or composite particles often include between about 10 wt % and about 90 wt % actives, such as 10 wt %-20 wt %, 20 wt %-30 wt %, 30 wt %-40 wt %, 40 wt %-50 wt %, 50 wt %-60 wt %, 60 wt %-70 wt %, 70 wt %-80 wt %, or 80 wt %-90 wt % actives, often 20 wt % to 80 wt % actives, or 20 wt % to 50 wt % actives, or even 20 wt % to 40 wt % actives.

In any one or more first embodiments herein, the composite particles have a layered arrangement of the iron sulfide remediation agent and the elution retarder, such as a core-shell arrangement. In some such embodiments, the layered composite particles include at least two distinct layers, and in embodiments up to 100 distinct layers or more, of one or more iron sulfide remediation agents and one or more elution retarders. In some first embodiments herein, the layered composite particles include an alternating layering of one more iron sulfide remediation agents, wherein the one or more iron sulfide remediation agents are the same or different. In some first embodiments herein, the layered composite particles include an alternating layering of one more elution retarders, wherein the one or more elution retarders are the same or different. In some first embodiments herein, the layered composite particles include an alternating layering of a iron sulfide remediation agent and an elution retarder, wherein each iron sulfide remediation agent layer includes the same or a different iron sulfide remediation agent, and each elution retarder layer includes the same or a different elution retarder.

Accordingly, in some first embodiments, the composite particles have a layered heterogeneous arrangement as noted above; in some such embodiments the layered arrangement is a multilayered arrangement. In other first embodiments, the composite particles include a mixture of the iron sulfide remediation agent and the elution retarder that is a heterogeneous mixture that is not a layered mixture. In still other first embodiments, the composite particles include a mixture of the iron sulfide remediation agent and the elution retarder that is an intimate mixture, or even a homogeneous mixture of the iron sulfide remediation agent with the elution retarder.

In some first embodiments herein, the iron sulfide remediation agent comprises, consists essentially of, or consists of a gluconate salt; in some such embodiments the gluconate salt is sodium gluconate. In some first embodiments herein, the elution retarder comprises, consists essentially of, or consists of a coupling agent salt that is sodium silicate. In some first embodiments herein, the iron sulfide remediation agent comprises, consists essentially of, or consists of sodium gluconate, the elution retarder comprises a coupling agent salt comprising sodium silicate, and the weight ratio of sodium gluconate to sodium silicate in the particulate mixture is between 90:10 and 99:1, such as 90:10, 95:5, 97:3, 98:2, or 99:1. In some such embodiments, the elution retarder further includes a carrier; in some embodiments the carrier comprises, consists essentially of, or consists of a hydrophilic polymer or a silica gel.

In some embodiments, the particulate compositions of first embodiments further include one or more additional well treatment materials, such as one or more biocides, corrosion inhibitors, antiscale agents, paraffin inhibitors, or any combination thereof. Such additional well treatment materials are suitably blended with an iron sulfide remediation agent and are incorporated into the composite particles. Alternatively, such additional well treatment materials are suitably used to form one or more additional well treatment composite particulates, using any one or more methods of second embodiments herein; and the composite particles are admixed with the one or more additional well treatment composite particulates to form a particulate composition of first embodiments herein.

The particulate compositions of first embodiments are used in the elution methods of third and fourth embodiments herein to remediate iron sulfide in a distressed water.

### Second Embodiments

Second embodiments herein are methods of forming a composite particulate of first embodiments, the method comprising, consisting essentially of, or consisting of contacting an iron sulfide remediation agent with an elution retarder to form a particulate composition comprising, consisting essentially of, or consisting of composite particles, wherein a composite particle includes both the iron sulfide remediation agent and the elution retarder present in the particle.

In a first alternative method of second embodiments herein, contacting an iron sulfide remediation agent with an elution retarder comprises, consists essentially of, or consists of: dissolving or dispersing an iron sulfide remediation agent in a first solvent to form an iron sulfide remediation agent solution, then contacting the iron sulfide remediation agent solution with an elution retarder, then removing at least a portion of the first solvent from the contacted combination. In some such embodiments, the first solvent is water, methanol, ethanol, isopropanol, or a mixture of any two or more thereof. In some such embodiments, the concentration of the iron sulfide remediation agent in the first solvent is between 1 wt % and 50 wt %, such a 1 wt % to 10 wt %, or 10 wt % to 20 wt %, or 20 wt % to 30 wt %, or 30 wt % to 40 wt %, or even 40 wt % to 50 wt %. In some such embodiments, the contacting is accomplished using conventional mixing techniques such as pouring or spraying the iron sulfide remediation agent solution onto the elution retarder, dispersing the elution retarder in the iron sulfide remediation agent solution, admixing the iron sulfide remediation agent solution with an elution retarder, and the like. In some such embodiments, removing at least a portion of the first solvent is accomplished by heating, applying a vacuum, applying a convection flow of air, placing the contacted combination in an open vessel and allowing the solvent to evaporate, or any combination of these.

In some first alternative methods of second embodiments, a non-solvent is added to the contacted combination prior to removing first solvent, wherein addition causes one or both of the elution retarder and the iron sulfide remediation agent to precipitate from the contacted combination; and the non-solvent is then removed along with the first solvent. Non-solvents herein are defined as solvents that are miscible with the solvent(s) present in the contacted combination, but cause the solids dissolved or dispersed therein to precipitate from solution. Examples of non-solvents operable in first alternative methods of second embodiments include methanol, ethanol, isopropanol, butanol, and acetone. Where a non-solvent is added to a contacted combination of first alternative methods of second embodiments herein, the first solvent and the non-solvent are suitably removed by filtration of the precipitate from the solvents, followed by drying of the filtrate.

In first alternative methods of second embodiments herein, upon removal of at least a portion of the first solvent, the resulting composition is a particulate composition that is ready for use in third and subsequent embodiments as described herein below. In other first alternative methods, the composition resulting from removal of at least some of the first solvent is film- or coating-like, and obtains a continuous dry layer. In such first alternative methods, the film or coating is collected and comminuted to form a particulate composition. The resulting particulate composition obtains a volume-based average particle size, or an particle size determined by classifying screens that is between 1 μm and 4 mm, as noted in first embodiments above; that is, a particle size of 1 μm to 5 μm, 5 μm to 10 μm, 10 μm to 20 μm, 20 μm to 50 μm, 50 μm to 100 μm, 100 μm to 200 μm, 200 μm to 500 μm, 500 μm to 1 mm, 1 mm to 2 mm, 2 mm to 3 mm, or 3 mm to 4 mm. In any one or more first embodiments herein, the particles of the particulate composition obtain a particle size via classifying screens that is between 1 μm and 2 mm, for example 1 μm to 5 μm, 5 μm to 10 μm, 10 μm to 20 μm, 20 μm to 50 μm, 50 μm to 100 μm, 100 μm to 200 μm, 200 μm to 500 μm, 500 μm to 1 mm, 1 mm to 2 mm, 2 mm to 3 mm, or 3 mm to 4 mm.

In some first alternative methods of second embodiments herein, one or more additional aliquots of the iron sulfide remediation agent solution are applied to the contacted combination, and/or to the particulate composition, followed by addition of non-solvent and filtration following by drying, or by drying and optionally comminuting to provide a layered particulate composition.

In a second alternative method of second embodiments herein, the contacting comprises, consists essentially of, or consists of: dissolving the elution retarder in a second solvent to form an elution retarder solution, then contacting the elution retarder solution with the iron sulfide remediation agent, then removing at least a portion of the second solvent from the contacted combination. In some such second alternative method of second embodiments herein, the second solvent is water, methanol, ethanol, isopropanol, or a mixture of any two or more thereof. In some such second alternative method of second embodiments herein, the concentration of the elution retarder in the second solvent is between 1 wt % and 50 wt %, such a 1 wt % to 10 wt %, or 10 wt % to 20 wt %, or 20 wt % to 30 wt %, or 30 wt % to 40 wt %, or even 40 wt % to 50 wt % of the elution retarder in the second solvent. In some such second alternative method of second embodiments herein, the contacting is accomplished using conventional mixing techniques. In some such second alternative methods of second embodiments herein, removing at least a portion of the second solvent is heating, applying a vacuum, applying a convection flow of air, allowing the solvent to evaporate, or any combination of these. In some such second alternative methods of second embodiments herein, upon removal of at least a portion of the second solvent, the resulting composition is a particulate composition that is ready for use in third and subsequent embodiments as described herein below. In other second alternative methods of second embodiments herein, the composition resulting from removal of at least some of the second solvent is film- or coating-like, and obtains a continuous dry layer. In such second alternative methods, the coating or film is collected and comminuted to form a particulate composition. The resulting particulate composition obtains a volume-based average particle size, or a particle size determined by classifying screens that is between 1 μm and 4 mm, as noted in first embodiments above.

In some second alternative methods of second embodiments herein, a non-solvent is added to the contacted combination prior to removing second solvent, wherein addition causes one or both of the elution retarder and the iron sulfide remediation agent to precipitate from the contacted combination; and the non-solvent is then removed along with the second solvent. Non-solvents herein are any of the non-solvents listed above. Where a non-solvent is added to a contacted combination of second alternative methods of second embodiments herein, the second solvent and the non-solvent are suitably removed by filtration of the precipitate from the solvents, followed by drying of the filtrate.

In some second alternative methods of second embodiments herein, one or more additional aliquots of the elution retarder solution are applied to the contacted combination, or to the particulate composition, followed by addition of non-solvent and filtration following by drying, or by drying and optionally comminuting to provide a layered particulate composition.

In a third alternative method of second embodiments herein, the contacting comprises, consists essentially of, or consists of: dissolving the iron sulfide remediation agent in a first solvent to form an iron sulfide remediation agent solution, dissolving the elution retarder in a second solvent to form an elution retarder solution, contacting the iron sulfide remediation agent solution with the elution retarder solution, then removing at least a portion of the first and second solvents from the contacted combination. In some such third alternative methods of second embodiments herein, the first solvent is the same as the second solvent. In some such third alternative methods of second embodiments herein, the first solvent, the second solvent, or both the first solvent and the second solvent are selected from water, methanol, ethanol, isopropanol, or a mixture of any two or more thereof. In some such third alternative methods of second embodiments herein, the contacting is accomplished using conventional mixing techniques. In some such third alternative methods of second embodiments herein, removing at least a portion of the first and second solvents is heating, applying a vacuum, applying a convection flow of air, allowing the solvents to evaporate, or any combination of these.

In some third alternative methods of second embodiments herein, a non-solvent is added to the contacted combination prior to removing first and second solvents, wherein addition causes one or both of the elution retarder and the iron sulfide remediation agent to precipitate from the contacted combination; and the non-solvent is then removed along with the first and second solvents. Non-solvents herein are any of the non-solvents listed above. Where a non-solvent is added to a contacted combination of third alternative methods of second embodiments herein, the first solvent, second solvent, and non-solvent are all suitably removed by filtration of the precipitate from the solvents, followed by drying of the filtrate.

In some third alternative methods of second embodiments herein, upon removal of at least a portion of the first and second solvent, the resulting composition is a particulate composition in accordance with first embodiments herein, and is suitably used as set forth in third and subsequent embodiments as described herein below. In other third alternative methods of second embodiments herein, the composition resulting from removal of at least some of the first and second solvent of second embodiments herein is film- or coating-like, and obtains a continuous dry layer. In such third alternative methods of second embodiments herein, the coating/film is collected and comminuted to form a particulate composition. The resulting composite particles obtain a volume-based average particle size, or an average particle dimension in at least one direction that is between 1 μm and 4 mm, as noted in first embodiments above.

In some third alternative methods of second embodiments herein, one or more additional aliquots of the elution retarder solution are applied to the contacted combination, or to the particulate composition, followed by addition of non-solvent and filtration following by drying, or by drying and optionally comminuting to provide a layered particulate composition. In some third alternative methods of second embodiments herein, one or more additional aliquots of the iron sulfide remediation agent solution are applied to the contacted combination, or to the particulate composition, followed by drying and optionally comminuting to provide a layered particulate composition. In some third alternative methods of second embodiments herein, layering of additional elution retarder solution and additional iron sulfide remediation agent solution is carried out by applying each of the solutions alternatively, with drying in between each applying step. In some such third alternative methods, between 1 and 100 additional layers of elution retarder solution and/or additional layers of iron sulfide remediation agent are applied to a contacted combination or a particulate composition to form the layered particulate composition.

In fourth alternative methods of second embodiments herein, the methods include dissolving or dispersing an iron sulfide remediation agent and a first elution retarder in a first solvent to form a combined solution, and dissolving or dispersing a second elution retarder in a second solvent to form an elution retarder solution, then contacting the combined solution with the elution retarder solution, then removing at least a portion of the first and second solvents from the contacted combination. In some such embodiments, a non-solvent is added to the contacted combination prior to removing first and second solvents, wherein addition causes one or more of the first elution retarder, the second elution retarder, and the iron sulfide remediation agent to precipitate from the contacted combination; and the non-solvent is then removed along with the first and second solvents. Non-solvents herein are any of the non-solvents listed above. Where a non-solvent is added to a contacted combination of fourth alternative methods of second embodiments herein, the first solvent, second solvent, and non-solvent are all suitably removed by filtration of the precipitate from the solvents, followed by drying of the filtrate. The resulting composite particles obtain a volume-based average particle size, or an average particle dimension in at least one direction that is between 1 μm and 4 mm, as noted in first embodiments above.

In fifth alternative methods of second embodiments herein, the methods include dissolving or dispersing an iron sulfide remediation agent and a first elution retarder in a first solvent to form a combined solution, then removing at least a portion of the first solvent from the combined solution to provide a first dried combination; then dissolving or dispersing a second elution retarder in a second solvent to form an elution retarder solution, then contacting the first dried combination with the elution retarder solution to form a contacted combination, then removing at least a portion of the second solvent from the contacted combination. In some fifth alternative methods of second embodiments herein, a non-solvent is added to the combined solution prior to removing the first solvent, wherein addition causes one or more of the first elution retarder and the iron sulfide remediation agent to precipitate from the combined solution; and the non-solvent is then removed along with the first solvent. In some fifth alternative methods of second embodiments herein, a non-solvent is added to the contacted combination prior to removing the second solvent, wherein addition causes the second elution retarder to precipitate; and the non-solvent is then removed along with the second solvent. Non-solvents herein are any of the non-solvents listed above. Where a non-solvent is added to a combined solution or a contacted combination of fifth alternative methods of second embodiments herein, any of the solvents present are all suitably removed by filtration of the precipitate from the solvents, followed by drying of the filtrate. The resulting composite particles obtain a volume-based average particle size, or an average particle dimension in at least one direction that is between 1 μm and 4 mm, as noted in first embodiments above.

Further, in some second embodiments herein, 1 and 100 additional layers of elution retarder solution and/or additional layers of iron sulfide remediation agent solution are applied to a contacted combination or to a particulate composition formed by a first alternative method of second embodiments herein, or to a contacted combination or a particulate composition formed by a second alternative method of second embodiments herein, or to or to a contacted combination or a particulate composition formed by a third alternative method of second embodiments herein, to form a layered particulate composition.

The particulate compositions of first embodiments herein, formed using the methods of second embodiments herein, are useful for remediating iron sulfide present in a distressed water, as set forth in subsequent embodiments herein. Further, as discussed in first embodiments herein, one or more additional well treatment materials may be incorporated into the composite particulates by admixing the iron sulfide remediation agent(s) with one or more additional well treatment materials, followed by forming a particulate composition using more methods of second embodiments herein. The one or more additional well treatment materials are useful for obtaining treatment of the well, such as antiscale treatment, paraffin inhibition treatment, corrosion inhibition treatment, biocide treatment, and the like. Alternatively, such additional well treatment materials are suitably used to form one or more additional well treatment composite particulates, using any one or more methods of second embodiments herein; and the composite particles are admixed with the one or more additional well treatment composite particulates to form a particulate composition of first embodiments herein.

### Third Embodiments

Third embodiments herein are treatment slurries comprising, consisting essentially of, or consisting of a fracturing fluid and one or more particulate compositions of first embodiments. In any one or more third embodiments herein, the fracturing fluid is any conventional fluid employed in hydraulic fracturing to establish a producing hydrocarbon well. Accordingly, in any one or more third embodiments herein, the fracturing fluid comprises or consists essentially of water, along with up to about 10 wt % total of one or more one or more nonionic, cationic, anionic, or zwitterionic surfactants, such as sodium dodecyl sulfate, alkyl ether sulfates, linear alkylbenzene sulfonates, ethoxylated alkylphenols such as ethoxylated nonylphenol, betaines, sulfobetaines, or cetyltrimethylammonium bromide; one or more friction reducers, such as polyacrylamide (emulsion or powder form), cationic or anionic polyacrylamide, or copolymers thereof; one or more scale inhibitors, such as phosphates, phosphate esters, phosphoric acid, phosphonates, phosphonic acid, polyacrylamide, salts of acrylamidomethyl propane sulfonate/acrylic acid copolymer (AMPS/AA), phosphinated maleic copolymer (PHOS/MA), or salts of polymaleic acid/acrylic acid/acrylamido-methyl propane sulfonate terpolymer (PMA/AMPS); one or more clay stabilizers, such as inorganic salts including KCl, poly(diallyldimethyl ammonium chloride) (poly(DADMAC)), quaternary ammonium compounds, or amine-based compounds; one or more biocides, such as glutaraldehyde, 2,2-Dibromo-3-nitrilopropionamide (DBNPA), tetrakis(hydroxymethyl)phosphonium sulfate (THPS), isothiazolinones (including blends such as chloromethylisothiazolinone and methylisothiazolinone), quaternary ammonium compounds including benzalkonium chloride, didecyldimethylammonium chloride, or more paraffin inhibitors, such as dodecyl benzene sulfonic acid (DDBSA), aromatic solvents including xylene and toluene, ethylene-vinyl acetate copolymers (EVA), or maleic anhydride copolymers (MA); one or more breakers, such as enzymes, persulfates, or hydrogen peroxide, or an encapsulated version of one of these; one or more chelating agents, such as ethylenediaminetetraacetic acid (EDTA), hydroxyethylenediaminetriacetic acid (HEDTA), ethylenetriaminepentaacetic acid (DTPA), amine-based surfactants, ethoxylated alkanols such as ethoxylated nonylphenol, or alkyl polyglucosides; one or more crosslinking agents, such as sodium borate (borax) or another borate salt; or any combination of these dissolved or dispersed therein.

In any one or more third embodiments herein, the treatment slurry comprises or consists essentially of a fracturing fluid and one or more particulate compositions of first embodiments herein. A particulate composition of first embodiments is suitably admixed with the fracturing fluid to form a treatment slurry of third embodiments. In any one or more third embodiments herein, the particulate composition of first embodiments is present in the treatment slurry in an amount of about 1 ppm by weight to about 50 wt % of the treatment slurry, that is, 1 ppm to 10 ppm by weight, 10 ppm to 50 ppm by weight, 50 ppm to 100 ppm by weight, 100 ppm to 500 ppm by weight, 500 ppm to 1000 ppm by weight, 1000 ppm to 5000 ppm by weight, 5000 ppm by weight to 0.1 wt %, 0.1 wt % to 0.2 wt %, 0.2 wt % 0.4 wt %, 0.4 wt % to 0.6 wt %, 0.6 wt % to 0.8 wt %, 0.8 wt % to 1.0 wt %, 1.0 wt % to 1.2 wt %, 1.2 wt % to 1.4 wt %, 1.4 wt % to 1.6 wt %, 1.6 wt % to 1.8 wt %, 1.8 wt % to 2.0 wt %, 2.0 wt % to 3.0 wt %, 3.0 wt % to 4.0 wt %, 4.0 wt % to 5.0 wt %, 5.0 wt % to 6.0 wt %, 6.0 wt % to 7.0 wt %, 7.0 wt % to 8.0 wt %, 8.0 wt % to 9.0 wt %, 9.0 wt % to 10.0 wt %, 10 wt % to 11 wt %, 11 wt % to 12 wt %, 12 wt % to 13 wt %, 13 wt % to 14 wt %, 14 wt % to 15 wt %, 15 wt % to 16 wt %, 16 wt % to 17 wt %, 17 wt % to 18 wt %, 18 wt % to 19 wt %, 19 wt % to 20 wt %, 20 wt % to 25 wt %, 25 wt % to 30 wt %, 30 wt % to 35 wt %, 35 wt % to 40 wt %, 40 wt % to 45 wt %, or 45 wt % to 50 wt % of the treatment slurry, often about 1 wt % to 20 wt % or even 5 wt % to 15 wt %, such as about 5 wt %, about 6 wt %, about 7 wt %, about 8 wt %, about 9 wt %, about 10 wt %, about 11 wt %, about 12 wt %, about 13 wt %, about 14 wt %, or about 15 wt % of the slurry.

In any one or more third embodiments herein, the treatment slurry further comprises a proppant. A proppant is a solid particulate material, typically sand, treated sand or man-made ceramic materials, having a particle size designed to keep an induced hydraulic fracture open following a fracturing treatment of a subterranean reservoir. The proppant is insoluble in the fracturing fluid. In any one or more third embodiments herein, the proppant is present in the treatment slurry in an amount of about 1 wt % to 50 wt % of the treatment slurry, for example 0.1 wt % to 1 wt %, 1 wt % to 2 wt %, 2 wt % to 3 wt %, 3 wt % to 4 wt %, 4 wt % to 5 wt %, 5 wt % to 6 wt %, 6 wt % to 7 wt % 7 wt % to 8 wt % 8 wt % to 9 wt %, 9 wt % to 10 wt %, 10 wt % to 11 wt %, 11 wt % to 12 wt %, 12 wt % to 13 wt %, 13 wt % to 14 wt %, 14 wt % to 15 wt %, 15 wt % to 20 wt %, 20 wt % to 25 wt %, 25 wt % to 30 wt %, 30 wt % to 35 wt %, 35 wt % to 40 wt %, 40 wt % to 45 wt %, or 45 wt % to 50 wt % in the treatment slurry.

Accordingly, in any one or more third embodiments herein, a treatment slurry comprises, consists essentially of, or consists of water, about 1 ppm by weight to about 10% by weight of one or more particulate compositions of first embodiments herein based on the weight of the treatment slurry; 0 wt % to 15 wt % of one or more proppants based on the weight of the treatment slurry; and 0 wt % to 10 wt % total of one or more polymers, surfactants, salts, cosolvents, pH adjustment agents, or other adjuvants based on the weight of the treatment slurry.

### Fourth Embodiments

Fourth embodiments herein are methods of treating a distressed water source to form a treated water source by contacting the distressed water source with a particulate composition of first embodiments herein, wherein the distressed water source is a water source including a measurable amount of iron sulfide dispersed or precipitated therein; and the treated water source is the distressed water source that has a reduced amount of iron sulfide measurable therein, compared to the distressed water source. In some embodiments, a treated water source includes no measurable iron sulfide. The measurable amount of iron sulfide includes both iron sulfide dispersed as solid particles in the water source, and iron sulfide attached to a solid interface with the water source, referred to industrially as iron sulfide scale.

In any one or more fourth embodiments herein, the distressed water source is a produced water that is present within a subterranean reservoir, and is flowing towards an oil or gas well head established on the surface of the earth, or subsea; and/or the distressed water source is present within one or more pipes, tubes, vessels, or other infrastructure associated with an established oil or gas well. In such fourth embodiments, the methods of treating comprise, consist essentially of, or consist of injecting a slurry of third embodiments into the subterranean reservoir. In any one or more fourth embodiments herein, the injecting is carried out contemporaneously with a well fracturing operation. In any one or more fourth embodiments herein, the well fracturing operation is a horizontal well fracturing operation.

Where the injecting of fourth embodiments is carried out during well fracturing operation, the fracturing obtains a pressurized flow of produced water toward the established well head as a result of releasing pressure on the subterranean contents of the reservoir. This pressurized flow is referred to industrially as flowback. The flowback of produced water includes the valuable crude oil product, which is collected and purified. The flowback of produced water into the well continues for a period of about 5 days to about 120 days, often about 30 days to 90 days after fracturing, that is, after establishing the well. Any treatment materials injected in the subterranean reservoir are continuously urged toward the well head by the outward flow of produced water emanating from the reservoir. The flowback can quickly deplete water soluble treatment materials from the reservoir.

Where the produced water flowing back after establishment of a well includes iron sulfide, and/or a mixture of hydrogen sulfide or sulfide-reducing bacteria that gives rise to iron sulfide formation, the produced water is a distressed water source. Flowback of distressed produced water requires treatment with an iron sulfide remediation agent to reduce the amount of iron sulfide dispersed therein, and/or able to form, and/or available to adhere to the well infrastructure such as pipes and tubes. Conventional solid particulate iron sulfide remediation agents, such as EDTA or sodium gluconate that are injected directly into the reservoir during fracturing of an oil or gas well are quickly dissolved and depleted as the flow of produced water dissolves and carries these agents out of the well. Once the iron sulfide remediation agent is depleted from the reservoir, iron sulfide can form and/or accumulate on pipe/tube or vessel surfaces, leading to “souring” of the well and early abandonment thereof in some instances.

We have found that by using the methods of fourth embodiments to inject a treatment slurry of third embodiments into the well during well completion (fracturing), the iron sulfide remediation period is extended when compared to the remediation period obtained by injecting the same amount of iron sulfide remediation agent alone. The remediation period is the period of reduced growth rate of iron sulfide scale; or the period during which no measurable iron sulfide scale is formed in a water source known to have or form iron sulfide in the absence of any treatment; or the remediation period is the period during which a reduced amount of dispersed iron sulfide is measured in a flowing water source; or the period during which no iron sulfide is measured in a flowing water source known to have or form iron sulfide dispersed therein in the absence of any treatment. The methods of fourth embodiments herein obtain a remediation period that is longer than the remediation period obtained by injecting the same amount of the same iron sulfide remediation agent alone. The methods of fourth embodiments herein obtain a remediation period that is longer than the remediation period obtained by injecting the same amount of the same iron sulfide remediation agent in the absence of the elution retarder. Using the methods of fourth embodiments herein, the remediation period is extended at least 10% compared to the remediation period obtained by injecting the same amount of the same iron sulfide remediation agent but in the absence of the elution retarder, and in embodiments the remediation period is extended at least 10% and as much as 600% or even more, such as 10%-15% or 15% to 20%, or 20% to 25%, or 25% to 30%, or 30% to 35%, or 35% to 40%, or 40% to 45%, or 45% to 50%, or 50% to 55%, or 55% to 60%, or 60% to 65%, or 65% to 70%, or 70% to 75%, or 75% to 80% or 80% to 85%, or 85% to 90%, or 90% to 95%, or 95% to 100%, or 100% to 150%, or 150% to 200%, or 200% to 250%, or 250% to 300%, or 300% to 350%, or 350% to 400%, or 400% to 450%, or 450% to 500%, or 500% to 550%, or 550% to 600%, or even more than 600% compared to the remediation period obtained by injecting the same amount of the same iron sulfide remediation agent but in the absence of the elution retarder.

The methods of fourth embodiments herein provide iron sulfide remediation of the subterranean reservoir for a remediation period of time that is at least 10% longer than the remediation period obtained using the same method but carried out in the absence of the elution retarder. In terms of days after establishment of a well by injecting a slurry of third embodiments during a fracturing treatment, the methods of fourth embodiments herein can obtain iron sulfide remediation for a flowback period of at least 10 days, in some embodiments up to 12 days, 14 days, 21 days, 28 days, 35 days, 42 days, 49 days, 56 days, 63 days, 70 days, 77 days, 84 days, or even 90 days or more, as determined by measuring an amount of iron sulfide remediation agent in the produced water flowback. In sharp contrast, in the absence of the elution retarder, the same amount of the same iron sulfide remediation agent injected during the same fracturing treatment obtains iron sulfide remediation for a flowback period of only 5-9 days.

### Fifth Embodiments

Fifth embodiments herein are elution compositions comprising, consisting essentially of, or consisting of an admixture of a particulate composition of first embodiments with an elution medium. In any one or more fifth embodiments herein, the elution medium is a solid particulate material that is chemically inert to the components of the particulate composition and also to water and aqueous fluids. In any one or more fifth embodiments herein, the elution medium comprises, consists essentially of, or consists of spherical or nearly spherical particles having a volume-based average or median particle size of at least 10 μm, or at least 100 μm, or at least 250 μm, or at least 500 μm; or the elution medium comprises, consists essentially of, or consists of a particle measured in at least one direction to be at least 10 μm, or at least 100 μm, or at least 250 μm, or at least 500 μm.

In any one or more fifth embodiments herein, the elution medium is sand, crosslinked polymer beads, or cuttings/fines obtained from a fractured formation. In some fifth embodiments, the particle size of the elution medium is 5-100 mesh using ASTM mesh units (corresponding to about 150 μm to 4 mm), that is, 5-10 mesh, 10-15 mesh, 15-20 mesh, 20-25 mesh, 25-20 mesh, 25-30 mesh, 30-35 mesh, 35-40 mesh, 40-45 mesh, 45-50 mesh, 50-55 mesh, 55-60 mesh, 60-65 mesh, 65-70 mesh, 70-75 mesh, 75-80 mesh, 80-85 mesh, 85-90 mesh, 90-95 mesh, 95-100 mesh, or a mixture of two or more different mesh size particles.

In any one or more fifth embodiments herein, the weight ratio of the particulate composition to the elution medium in the elution composition is between 100:1 and 1:100 by weight, such as 100:1 to 1:1, 50:1 to 1:1, 20:1 to 1:1, 100:1 to 90:1, 90:1 to 80:1, 80:1 to 70:1, 70:1 to 60:1, 60:1 to 50:1, 50:1 to 40:1, 40:1 to 30:1, 30:1 to 20:1, 20:1 to 18:1, 18:1 to 16:1, 16:1 to 14:1, 14:1 to 12:1, 12:1 to 10:1, 10:1 to 9:1, 9:1 to 8:1, 8:1 to 7:1, 7:1 to 6:1, 6:1 to 5:1, 5:1 to 4:1, 4:1 to 3:1, 3:1, to 2:1, 2:1 to 1:1, 1:1 to 1:2, 1:2 to 1:3, 1:3k to 1:4, 1:4 to 1:5, 1:5 to 1:6, 1:6 to 1:7, 1:7 to 1:8, 1:8 to 1:9, 1:9 to 1:10, 1:10 to 1:12, 1:12 to 1:14, 1:14 to 1:16, 1:16 to 1:18, 1:18 to 1:20, 1:20 to 1:30, 1:30 to 1:40, 1:40 to 1:50, 1:50 to 1:60, 1:60 to 1:70, 1:70 to 1:80, 1:80 to 1:90, or 1:90 to 1:100 of the particulate composition to the elution medium in the elution composition by weight. In some fifth embodiments herein, the weight ratio of the particulate composition to the elution medium in the elution composition is between 10:1 and 1:10, such as 10:1 to 1:1 or 1:1 to 1:10.

In any one or more fifth embodiments herein, the elution composition is suitably formed by admixing the particulate composition with the elution medium using conventional methods for mixing two particulate materials. In some third embodiments, the elution composition is formed by admixing the particulate composition with the elution medium in the absence of a solvent, for example by rolling, shaking, or paddle mixing the particulate composition particles with the elution medium particles. The particulate composition and the elution medium are suitably admixed in a single addition of one to the other; or the particulate composition is added slowly or in aliquots to the elution medium during the mixing; or the elution medium is added slowly or in aliquots to the particulate composition during the mixing.

### Sixth Embodiments

Sixth embodiments herein are elution devices for eluting one or more iron sulfide remediation agents therefrom. The elution devices of include an interior volume defining one or more inlets thereto and one or more outlets therefrom, wherein the interior volume comprises an elution composition of fifth embodiments disposed therein. In any one or more sixth embodiments herein, at least one inlet of the elution device is arranged to receive an eluant and direct the eluant into the interior volume of the elution device and further into eluting contact with the elution composition disposed therein, to form an eluate; and least one outlet of the elution device is arranged to receive and dispense an eluate from the elution device. The dissolution of an amount of iron sulfide remediation agent (present in the particulate composition of the elution composition) by the eluate to form an eluant is referred to herein as eluting contact. The eluate, formed by the eluting contact, is dispensed from an outlet of the elution device. In some sixth embodiments herein, the at least one outlet of the elution device is further arranged and adapted to dispense an eluate directly into a distressed water source.

In some sixth embodiments herein, the elution device is designed and adapted to passively receive an eluant through an inlet of the elution device and provide eluting contact of the eluant with the elution composition disposed therein, forming an eluate which flows through an outlet of the elution device. Such passive elution devices do not require, and in some embodiments suitably exclude, external or applied sources of power to obtain operation thereof. In other embodiments, a pump or other externally powered means to apply pressurized flow is applied to an eluant to urge a flow of an eluant through an inlet of the elution device to obtain eluting contact, and to urge a flow of eluate toward an outlet thereof.

In some sixth embodiments, the elution device is operably mounted on a support. By “operably mounted” it is meant that the elution device is attached to an article such as a well completion component (e.g. a pipe, tube, cleat, clamp, nipple, or other well completion component), a beam, a wall, a geographic feature such as hill or a boulder, a vehicle, or another solid natural or man-made article capable of supporting the weight and dimensions of the elution device; and further wherein the elution device is positioned to obtain an eluant through an inlet thereof and dispense an eluate through an outlet thereof. In some such embodiments, the elution device, support, or both include one or more attachment means that are operable to attach, or mount, the elution device to the support. As used herein, “attachment means” include one or more clips, latches, brackets, rivets, screws, nails, snaps, buttons, ties, clamps, straps, adhesive compositions, hook and loop or other mating fasteners, combinations of these, and similar items as well as adjunct equipment including braces, extension bars, brackets, handles, quick-release mechanisms, and the like as will be familiar to those of skill. In some embodiments, attachment means comprises, consists essentially of, or consists of gravity. In some such embodiments, the one or more attachment means are operable to removably mount the elution device to the support.

In some sixth embodiments, the elution device includes one or more additional features, such as one or more valves, pressure gauges, liquid flow meters, windows for viewing the contents of the elution device interior, means for measuring the amount of the iron sulfide remediation agent and/or the amount of the elution composition and/or the amount of the particulate composition that is present in the interior volume (such as a scale to weigh the contents, a level meter, or a spectrometer).

In some sixth embodiments herein, the elution device includes a cap, lid, door, or other removable or partially removable portion thereof. The removable or partially removable portion is disposed and adapted to provide a user with access to the interior volume of the elution device, and the elution composition disposed therein. In such embodiments, replenishment or replacement of the elution composition is easily carried out, and inspection of the elution device, and the elution composition contained therein, is easily conducted.

### Seventh Embodiments

Seventh embodiments herein are methods of eluting an iron sulfide remediation agent, the methods comprising, consisting essentially of, or consisting of applying a flow of an eluate through at least one of the one or more inlets of the elution device of sixth embodiments herein, wherein the applied flow contacts an elution composition disposed within the interior volume of the elution device, forming an eluate comprising an amount of the iron sulfide remediation agent dissolved therein; and dispensing the eluate from the interior volume of the elution device through one or more outlets thereof. In some seventh embodiments, the eluate is a water source comprising, consisting essentially of, or consisting of water; in some embodiments, the eluate is tap water, lake water, ocean water, pond water, runoff water, gray water, or produced water.

In some seventh embodiments, the eluate is dispensed into a vessel, container, or receptacle; in other embodiments the eluate is dispensed directly into a distressed water source, forming a treated water source. Contacting the distressed water source with the eluate transforms the distressed water source into a treated water source. In some seventh embodiments, the distressed water source is a produced water, and the treated water source is a treated produced water. In some such embodiments, the eluant is also a distressed water source. In some embodiments the eluant is a produced water.

Accordingly, also disclosed in seventh embodiments herein are methods of treating a distressed water source, which is a water source including iron sulfide dispersed or precipitated therein. The methods of seventh embodiments comprise, consist essentially of, or consist of directing a flow of an eluant through an inlet of an elution device of fourth embodiments and into the interior volume thereof, to cause eluting contact of the water source with the elution composition disposed in the interior volume of the elution device, forming an eluate comprising, consisting essentially of, or consisting of an iron sulfide remediation agent and the water source; and dispensing the eluate into a distressed water source to convert the distressed water source to a treated water source.

In some seventh embodiments herein, a flow of eluant is directed through an inlet of an elution device of sixth embodiments at a flow rate of about 1 liter per hour to 10 liters per second. In other embodiments a flow rate of eluant is directed through an inlet of an elution device of sixth embodiments at a flow rate of about 100 liters per hour to about 3500 liters per hour. The eluant enters the elution device and dissolves an amount of the iron sulfide remediation agent present in the elution composition, to form an eluate.

In some seventh embodiments herein, the methods comprise, consist essentially of, or consist of mounting an elution device to a support, the elution device having an interior volume comprising an elution composition, one or more inlets to the interior volume, and one or more outlets from the interior volume; applying a flow of eluant through the inlet and into the interior volume, wherein the eluant obtains eluting contact with the elution composition, forming an eluate comprising an amount of the iron sulfide remediation agent dissolved therein; and dispensing the eluate into a distressed water or proximal to a distressed water. In embodiments, the amount of iron sulfide remediation agent present in the eluate is at least 1 μmole per liter of the eluate. In embodiments, the amount of iron sulfide remediation agent present in the eluate is at least 0.1 ppm by weight and as much as 1000 ppm by weight of the eluate.

Also disclosed in seventh embodiments herein are methods of treating a distressed water present within a wellbore of a subterranean reservoir, the methods comprising, consisting essentially of, or consisting of: obtaining a side stream flow of a produced water from a production tube of the wellbore; directing the side stream flow through an inlet and into the interior volume of an elution device of sixth embodiments herein; obtaining an eluting contact of the side stream flow of produced fluid with the elution composition disposed in the interior volume of the elution device to form a side stream flow of treated produced fluid; and directing the side stream flow of treated produced fluid through the outlet of the elution device and into the wellbore at a location at or below the surface of the earth. In embodiments the treating is continuous treating. In embodiments, the side stream flow of produced fluid is obtained at a flow rate of about 1 liter per hour to 10 liters per second. In other embodiments, the side stream flow rate of produced fluid is about 100 liters per hour to about 3500 liters per hour.

### EXPERIMENTAL

### Example 1

5 g of sodium gluconate powder (CAS #: 527-07-1) was spread out in the sample area of a 250-mL disposable square weighing boat, or pan (below, “weighing pan”). Sodium silicate solution (38-40 wt %, CAS No. 1344 Sep. 8) was diluted to 8 wt % with water, and 1.75 g of the 8 wt % solution of sodium silicate was applied uniformly to the sodium gluconate powder, visibly wetting all the powder. The weighing pan containing the sodium gluconate-sodium silicate mixture was set in a 50° C. drying oven for one day. After drying, the mixture was observed to be solidified in the weighing pan. The solidified mixture was collected, crushed, and classified using screens to obtain 10-40 mesh size particles (ASTM mesh, about 2000 μm-400 μm).

### Example 2

Sodium gluconate was dissolved in water to form a 40 wt % solution; 12.5 g of the sodium gluconate solution was mixed with 8.33 g of sodium silicate solution (as supplied, 38-40 wt %) in a beaker. The contents of the beaker were poured into a weighing pan, and the weighing pan was set in a 50° C. drying oven for one day. After drying, the contents of the weighing pan were observed to be solidified. The solids were collected from the weighing pan, crushed, and classified using screens to obtain 10-40 mesh size particles (ASTM mesh, about 2000 μm-400 μm).

### Example 3

7.85 g of silica gel microcrystals (CAS #: 112926-00-8) were spread out evenly across the sample area of a weighing pan. Sodium gluconate was dissolved in water to form a 40 wt % solution; and 17.88 g of the 40 wt % sodium gluconate solution was applied to evenly wet the silica gel. The weighing pan was set in a 50° C. drying oven for one day. After drying, the contents of the weighing pan were observed to be solidified. The solid contents were allowed to cool to room temperature; then 13 g of a 20 wt % sodium silicate solution (diluted to 20 wt % from the 38-40 wt % solution as supplied) was applied to evenly wet the solid contents of the weighing pan. The weighing pan was then placed back in the 50° C. drying oven for a day. After drying, the contents of the weighing pan were solidified. The solidified contents were collected.

### Example 4

7.85 g of silica gel microcrystals (CAS #: 112926-00-8) were spread out evenly across the sample area of a weighing pan. Sodium gluconate was dissolved in water to form a 40 wt % solution; and 17.88 g of the 40 wt % sodium gluconate solution was applied to evenly wet the silica gel. The weighing pan containing the sodium gluconate-silica gel mixture was set in a 50° C. drying oven for one day. After drying, the contents of the weighing pan were solidified. The solid contents were allowed to cool to room temperature. Polyvinyl alcohol, 98% hydrolyzed (CAS No. 9002-89-5), having a weight average molecular weight of 13,000-23,000 g/mol was dissolved in water to form a 15 wt % solution, and 15 g of the polyvinyl alcohol solution was applied to evenly wet the solid contents of the weighing pan. The weighing pan was then placed back in the 50° C. drying oven for a day. After drying, the contents of the weighing pan were solidified. The solidified contents were collected.

### Example 5

Sodium gluconate was dissolved in water to form a 30 wt % solution. Polyvinyl alcohol, 98% hydrolyzed (CAS No. 9002-89-5), having a weight average molecular weight of 13,000-23,000 g/mol was separately dissolved in water to form a 15 wt % solution. Then 20 g of the sodium gluconate solution and 20 g of the polyvinyl alcohol solution were mixed in a beaker. The contents of the beaker were poured into a weighing pan, and the weighing pan was set in a 50° C. drying oven for one day. After drying, the contents of the weighing pan were observed to be a solidified layer on the bottom of the pan. The solids were collected from the weighing pan, crushed, and classified using screens to obtain particles having ASTM mesh size 10-40.

### Example 6

Sodium gluconate was dissolved in water to form a 30 wt % solution; and polyvinyl alcohol, 98% hydrolyzed (CAS No. 9002-89-5), having a weight average molecular weight of 13,000-23,000 g/mol was dissolved in water to form a 10 wt % solution. Then 20 g of the sodium gluconate solution was mixed with 1 g Evonik Sipernat® 50 S (CAS No. 112926-00-8) in a bottle. Sipernat® 50 S is a precipitated silica particulate having a d50 particle size (laser diffraction) of 18 μm and 500 m²/g surface area (obtained from Evonik Operations GmbH of Hanau-Wolfgang, Germany). Then 20 g of the polyvinyl alcohol solution was added to the bottle, and the bottle contents were mixed, then poured into a weighing pan. The weighing pan was set in a 50° C. drying oven for one day. The contents of the weighing pan were observed to be a solid layer on the bottom of the pan. The solids were collected, crushed, and classified using screens to obtain particles having ASTM mesh size 10-40.

### Example 7

Sodium gluconate was dissolved in water to form a 30 wt % solution; and polyvinyl alcohol, 98% hydrolyzed (CAS No. 9002-89-5), having a weight average molecular weight of 13,000-23,000 g/mol was dissolved in water to form a 10 wt % solution. Then 20 g of the sodium gluconate solution was mixed with 1 g of microcrystalline cellulose powder (CAS No. 9004-34-6) in a bottle. Then 20 g of the polyvinyl alcohol solution was added to the bottle, and the contents of the bottle were mixed. Finally, the contents of the bottle were poured into a weighing pan, and the weighing pan was set in a 50° C. drying oven for one day. After drying, the contents of the weighing pan were solidified. The solids were collected from the weighing pan, crushed, and classified using screens to obtain particles having ASTM mesh size 10-40.

### Example 8

Each of the particulate solids collected in Examples 1-7 were subjected to elution testing using the following Column Elution Protocol.

Column Elution Protocol: Mix the selected particulate with 10 wt % 40-mesh proppant sand (ASTM mesh size); pack a standard HPLC column with the 90/10 particulate/sand mixture, ensuring that the pore volume of the packed column is approximately 2.2-2.5 mL. Mount the packed HPLC column on a high-pressure liquid chromatograph, and set the column temperature to 70° C. Prepare a synthetic Permian basin brine (synthetic connate, similar to produced water) having the composition shown in Table 1. Inject the synthetic Permian basin brine as the eluant into the HPLC column at a continuous flow rate of 2 cc/min, and collect approximately 400 pore volumes of the resulting effluent, or eluate. Analyze the eluate using conventional LC-MS and spectroscopic methods, employing an enzymatic assay to determine gluconate concentration.

TABLE 1
Components and amounts in synthetic Permian basin brine.

| Salt | Wt, g |
|---|---|
| CaCl₂ (H₂O)₂ | 8.800 |
| MgCl₂ (H₂O)₆ | 2.374 |
| NaCl | 71.539 |
| KCl | 0.385 |
| NaHCO₃ | 0.041 |
| SrCl₂•6H₂O | 0.061 |
| Na₂SO₄ | 0.080 |
| water | 975.905 |

Using the foregoing Column Elution Protocol, eluates obtained from the particles of Examples 1-7 were analyzed continuously over the entire test period. The Column Elution Protocol was also carried out on a Control column packed with a 90/10 wt/wt mixture of sodium gluconate powder with 40-mesh proppant sand; and the approximate % increase in the number of pore volumes required to elute a 10 ppm concentration of sodium gluconate was determined for the columns containing the particles of Examples 1-7, by comparison to the number of pore volumes required to reach 10 ppm sodium gluconate in the eluate from the Control column.

Results of the analyses are shown in the FIGURE and in Table 2. The continuously analyzed results are plotted in the FIGURE to show the relationship between number of pore volumes eluted and the resulting concentration of sodium gluconate in the eluate over the entirety of the test. Additionally, Table 2 shows the approximate number of pore volumes of eluant injected to obtain 10 ppm by weight of sodium gluconate in the eluate for the particles of Examples 1-7 and the Control, and the approximate % increase in pore volume injected for the particles of Examples 1-7 compared to the Control.

TABLE 2
Approximate number of pore volumes of eluant (synthetic
Permian basin connate) injected to obtain 10 ppm sodium
gluconate by weight in the eluates of Example 8.

| | | Approximate % | |
|---|---|---|---|
| | Approximate # | increase in # of | |
| | pore volumes | pore volumes | |
| | injected to | injected to | Wt % sodium |
| | obtain 10 ppm | obtain 10 ppm | gluconate in |
| Example | sodium | sodium | the Example |
| No. | gluconate | gluconate | (without sand) |
| Control | 11 | N/A | 100 |
| 1 | 17.5 | 59.1 | 97 |
| 2 | 135 | 1127.3 | 60 |
| 3 | 52.5 | 377.3 | 41.5 |
| 4 | 52.5 | 377.3 | 41.5 |
| 5 | 37 | 236.4 | 66.7 |
| 6 | 23.5 | 118.2 | 66.7 |
| 7 | 33 | 200 | 66.7 |

As can be seen in Table 2, and also in the FIGURE, the particulates of Examples 1-7 all obtain a significant reduction in the rate of sodium gluconate elution compared to the CONTROL (sodium gluconate alone). Table 2 shows an increase of at least 50% in the number of pore volumes injected to obtain 10 ppm sodium gluconate; often the increase is more than 200% or even more than 300%; and in the case of Example 2, the % increase is greater than an order of magnitude.

Further, the rate of sodium gluconate release is not related in any discernible way to the amount of sodium gluconate in the Example particulates themselves (that is, prior to mixing with the sand and packing the column), since the particles of Example 2, which have 60 wt % sodium gluconate, elute sodium gluconate more slowly than the particles of Example 3 and 4 which have only 41.5 wt % sodium gluconate. Accordingly, sodium gluconate elution appears to be controlled primarily by presence or absence of one or more chemical interactions/attractions between the gluconate salt and the one or more elution retarder(s) present in the Example particles, and not directly related to the percent sodium gluconate present in the packed HPLC column.

What is claimed is:

1. A particulate composition comprising composite particles, the composite particles comprising an iron sulfide remediation agent and an elution retarder.

2. The particulate composition of claim 1 wherein the iron sulfide remediation agent comprises an iron sulfide chelating compound selected from phosphonate salts, phosphonium salts, organic acids and/or conjugate bases thereof, or any combination thereof.

3. The particulate composition of claim 2 wherein the iron sulfide chelating compound comprises an organic acid or conjugate base thereof comprising one or more hydroxy moieties and/or one or more tertiary amino moieties.

4. The particulate composition of claim 3 wherein the organic acid or conjugate base thereof is gluconic acid, a gluconate, ethylenediaminetetraacetic acid (EDTA), diethylenetriaminepentaacetic acid (DTPA), or any combination thereof.

5. The particulate composition of claim 3 wherein the organic acid or conjugate base thereof is sodium gluconate.

6. The particulate composition of claim 2 wherein the phosphonium salt is tetrakis(hydroxymethyl)phosphonium sulfate (THPS).

7. The particulate composition of claim 2 wherein the phosphonate salt has the formula 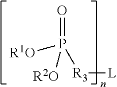
wherein each R¹ and R² are independently selected from hydrogen, sodium, potassium, ammonium, alkylammonium, alkanolammonium, magnesium, or calcium, each R³ is independently selected from C1-C4 hydrocarbyl, n is an integer between 1 and 5, and L is hydrogen or a linking moiety comprising one or more carbon atoms and/or one or more nitrogen atoms and/or one or more oxygen atoms.

8. The particulate composition of claim 1 wherein substantially all of the particles of the particulate composition are composite particles.

9. The particulate composition of claim 1 wherein the elution retarder comprises a coupling agent or salt thereof, a carrier, or any combination thereof, optionally wherein the coupling agent salt comprises a sodium, potassium, ammonium, alkylammonium, alkanolammonium, magnesium, or calcium silicate, titanate, stannate, or aluminate.

10. The particulate composition of claim 1 wherein the iron sulfide remediation agent comprises sodium gluconate, the elution retarder comprises a coupling agent salt comprising sodium silicate, and the weight ratio of sodium gluconate to sodium silicate in the particulate composition is between 1:99 and 99:1; or between 90:10 and 99:1.

11. The particulate composition of claim 1 wherein the carrier is a silica gel, a hydrophilic polymer, a charcoal, a clay, calcium sulfate, a diatomaceous earth, a zeolite, an alumina, a vermiculite, or any combination thereof.

12. The particulate composition of claim 11 wherein the hydrophilic polymer is a homopolymer, copolymer, derivative, salt, or crosslinked polymer comprising a polyvinyl alcohol, a polyacrylic acid, a polymethacrylic acid, a gelatin, a starch, alginic acid and/or sodium alginate, a chitosan, a dextran, a β-glucan, a fucoidan, a laminarin, an inulin, a pectin, a cellulose, a hemicellulose, a carboxymethylcellulose, a microcrystalline cellulose, a cellulose acetate, a hydroxymethylcellulose, or a hydroxyethylcellulose, optionally wherein the polyvinyl alcohol polymer comprises at least 80 mole % vinyl alcohol repeat units, and/or has a weight average molecular weight of about 5,000 g/mol to 100,000 g/mol.

13. The particulate composition of claim 1 wherein the ratio of the iron sulfide remediation agent to the elution retarder in the composite particles is between 99:1 and 1:99 by weight, or between 90:10 and 10:90 by weight.

14. A slurry comprising
a fracturing fluid,
a particulate composition comprising composite particles, the composite particles comprising an iron sulfide remediation agent and an elution retarder.

15. The slurry of claim 14 wherein the fracturing fluid comprises water, one or more friction reducers, scale inhibitors, clay stabilizers, biocides, paraffin inhibitors, breakers, crosslinking agents, surfactants, in-situ acid generators, chelating agents, tracers, tagging agents, or any combination thereof.

16. The slurry of claim 14 wherein the particulate composition is present in an amount of about 0.1 wt % to about 50 wt % of the slurry.

17. The slurry of claim 14 further comprising a proppant, wherein the proppant is present in an amount of about 1 wt % to 50 wt % of the slurry.

18. A method of treating a subterranean reservoir to remediate iron sulfide, the method comprising: injecting a slurry into the subterranean reservoir, the slurry comprising a fracturing fluid and a particulate composition comprising composite particles, the composite particles comprising an iron sulfide remediation agent and an elution retarder.

19. The method of claim 18 wherein the injecting is carried out during a well fracturing operation.

20. The method of claim 18 wherein the method provides iron sulfide remediation of the subterranean reservoir for period of time that is at least 10% longer than the same method carried out in the absence of the elution retarder; or for period of time that is at least 100% longer than the same method carried out in the absence of the elution retarder; or for period of time that is at least 500% longer than the same method carried out in the absence of the elution retarder.
